(19) United States
(12) Patent Application Publication
(10) Pub. No.: US 2014/0263420 A1
(43) Pub. Date: Sep. 18, 2014

(54) CNG DISPENSER

(71) Applicant: BPC Acquisition Company, Spring Lake, MI (US)

(72) Inventors: Sarah Ann Lambrix, Grand Haven, MI (US); Chad Robert Paffhausen, Spring Lake, MI (US); Adam Kenneth Simon, Norton Shores, MI (US); Jonathan M. Rathbun, Belmont, MI (US)

(73) Assignee: BPC Acquisition Company, Spring Lake, MI (US)

(21) Appl. No.: 14/210,954

(22) Filed: Mar. 14, 2014

Related U.S. Application Data
(60) Provisional application No. 61/793,754, filed on Mar. 15, 2013.

(51) Int. Cl. F17C 7/00

(52) U.S. Cl. CPC F17C 7/00
USPC 222/3

(57) ABSTRACT

According to one embodiment, a CNG dispenser is provided that includes a user-actuatable button for allowing selection of a pressure to which to fill a vehicle tank with CNG, and a controller for opening a high pressure fill valve to dispense high pressure CNG into the vehicle tank while monitoring the pressure of the vehicle tank until the pressure reaches the user-selected pressure. According to another embodiment, the controller is operable in a selected one of two modes of operation. The two modes of operation include a one-pressure bank operation mode in which only the input of a high pressure fill valve is coupled to a CNG supply line, and a three-pressure bank operation mode in which the inputs of each of three fill valves are coupled to respective CNG supply lines. A graphic fuel gage may be provided on the dispenser payment terminal screen.

### CROSS-REFERENCE TO RELATED APPLICATION

This application claims priority to and the benefit under 35 U.S.C. §119(e) of U.S. Provisional Patent Application No. 61/793,754, filed on Mar. 15, 2013, entitled “IMPROVED CNG DISPENSER,” by Sarah Ann Lambrix et al., the entire disclosure of which is incorporated herein by reference.

### BACKGROUND OF THE INVENTION

The present invention generally relates to dispensers for dispensing compressed natural gas (CNG) to vehicles.

### SUMMARY OF THE INVENTION

According to an embodiment of the present invention, a CNG dispenser is provided comprising: a cabinet; a fill hose extending from the cabinet; a pressure sensor disposed to sense a pressure within the fill hose that corresponds to a pressure of a vehicle tank when the fill hose is coupled to the vehicle tank; a high pressure fill valve disposed between a high pressure CNG supply line and the fill hose; at least one user-actuatable button disposed on the cabinet for allowing a user to select a pressure to which to fill the vehicle tank with CNG; and a controller coupled to the at least one user-actuatable button, the pressure sensor, and the high pressure fill valve for opening the high pressure fill valve to dispense high pressure CNG into the vehicle tank while monitoring the pressure of the vehicle tank as sensed by the pressure sensor until the pressure reaches the user-selected pressure.

According to another embodiment of the present invention, a CNG dispenser is provided comprising: a cabinet; a fill hose extending from the cabinet; a pressure sensor disposed to sense a pressure within the fill hose that corresponds to a pressure of a vehicle tank when the fill hose is coupled to the vehicle tank; a low pressure fill valve having an input configured to be coupled to a lower pressure CNG supply line, and an output coupled to the fill hose; a medium pressure fill valve having an input configured to be coupled to a medium pressure CNG supply line, and having an output coupled to the fill hose; a high pressure fill valve having an input configured to be coupled to a high pressure CNG supply line, and having an output coupled to the fill hose; and a controller coupled to the pressure sensor, and the low, medium, and high pressure fill valves, wherein the controller is operable in a selected one of two modes of operation that may be selected by an operator of a filling station where the CNG dispenser is located, the two modes of operation include a one-pressure bank operation mode in which only the input of the high pressure fill valve is coupled to a CNG supply line, and a three-pressure bank operation mode in which the inputs of each of the fill valves are coupled to respective CNG supply lines.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a hydraulic flow diagram in schematic form of CNG flow control components of a dispenser according to some of the embodiments;

FIG. 2 is an electrical circuit diagram in block form of electrical components of a dispenser according to some of the embodiments;

FIG. 3 is an elevational view of a front of a CNG dispenser in which the embodiments described herein are implemented;

FIG. 4 is an elevational view of a close-up of a portion of the front of the CNG dispenser of FIG. 3;

FIG. 5 is an elevational view of a display of the CNG dispenser of FIG. 3 showing a graphic fill indicator;

FIG. 6 is a hydraulic flow diagram in schematic form of CNG flow control components of a dispenser according to an alternative embodiment;

FIG. 7 is a hydraulic flow diagram in schematic form of CNG flow control components of a dispenser according to an another alternative embodiment; and

FIG. 8 is a hydraulic flow diagram in schematic form of CNG flow control components of a dispenser according to another alternative embodiment.

### DETAILED DESCRIPTION OF THE EMBODIMENTS

Reference will now be made in detail to the present preferred embodiments of the invention, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

FIG. 1 is a hydraulic flow diagram showing the CNG hydraulic components 210a of a dispenser 205 (FIG. 3). There are typically two to four lines that run between a dispenser and the pressure banks of a natural gas farm where the CNG is typically stored in one or three pressure banks. In typical CNG dispensers that are used with a one-pressure bank system, these lines include a vent line 252 and a supply line 216 that supplies CNG at a single high pressure to the dispenser. If the CNG dispensers are used with a three-pressure bank system, these lines include a vent line 252, and a first supply line 212 that supplies CNG at a first pressure to the dispenser, a second supply line 214 that supplies CNG at a second pressure (higher than the first pressure), and a third supply line 216 that supplies CNG at a third pressure (higher than the first and second pressures). Natural gas farms often store CNG at multiple pressures due to the cost of storing CNG at the high pressures (i.e., 3000 to 3600 psi) required for vehicles. More specifically, a natural gas farm may store CNG in a first pressure bank at 2000 psi, in a second pressure bank at 3000 psi, and in a third pressure bank at 4000 psi. When filling a vehicle tank up to 3600 psi, for example, CNG is first drawn off the first pressure bank through first supply line 212 until the vehicle tank is partially filled at 2000 psi, then CNG is drawn off the second pressure bank through second supply line 214 until the vehicle tank is partially filled at 3000 psi, and then CNG is drawn off the third pressure bank through third supply line 216 until the vehicle tank is completely filled at 3600 psi. The actual pressure at which the vehicle is filled may depend on ambient temperature as discussed further below. Because the CNG in the lower-pressure first and second pressure banks costs less to supply, the cost of filling a vehicle tank is reduced by filling the vehicle as much as possible by initially using the lower pressure first and second pressure banks to partially fill the vehicle tank.

Some of the embodiments described below provide a CNG dispenser 205 that may be configured with software to operate with either a one-pressure bank system or a three-pressure bank system. In this manner, a filling station would not have to switch CNG dispensers 205 when changing from a one-bank system to a three-bank system or vice versa.

Dispenser 205 further includes manual shut-off valves 218, 220, and 222 on supply lines 212, 214, and 216, respectively. Each of supply lines 212, 214, and 216 further includes a filter 224, 226, and 228, respectively. After filtration, each of supply lines 212, 214, and 216 is split into first and second branches 212a and 212b, 214a and 214b, and 216a and 216b, where the two branches are provided for the two vehicle fill hoses 230a and 230b that are positioned on either side of dispenser 205 (see also FIG. 3). In a typical CNG dispenser 205, one fill hose 230a is configured for supplying pressure to 3000 psi and the other fill hose 230b is configured for supplying pressure to 3600 psi. In some cases, a nozzle on fill hose 230a is shaped differently than a nozzle on fill hose 230b. For example, fill hose 230a may have a nozzle that is shaped to fit a vehicle fill connector of a vehicle that runs on CNG at a pressure of 3000 psi while fill hose 230b may have a nozzle that is shaped to fit a vehicle fill connector of a vehicle that runs on CNG at a pressure of 3600 psi. This is to prevent users from inadvertently using the wrong fill hose and filling their tank to the wrong pressure. However, having different fill hoses that operate at different predetermined pressures limits the number of available fill hoses at a filling station and makes it difficult for a user to pull up to a dispenser that may be available on one side only to find out that the fill hose needed is already in use at the other side of the dispenser 205. One embodiment addresses this problem by providing a CNG dispenser 205 that allows the user to select a pressure to be delivered through any one fill hose 230a, 230b. In other words, dispenser 205 may be configured to allow selection of a “grade” of CNG having either 3000 psi or 3600 psi to be dispensed through a single fill hose 230a, 230b. In this regard, fill hose 230a may have a nozzle 232a that is shaped to fit either of the available vehicle fill connector styles, and fill hose 230b may have a nozzle 232b that is also shaped to fit either of the available vehicle fill connector styles.

The first branches 212a, 214a, and 216a of supply lines 212, 214, and 216 include a respective low pressure fill valve 238a, medium pressure fill valve 240a, and high pressure fill valve 242a. Likewise, the second branches 212b, 214b, and 216b of supply lines 212, 214, and 216 include a respective low pressure fill valve 238b, medium pressure fill valve 240b, and high pressure fill valve 242b. The outputs of valves 238a, 240a, and 242a are coupled to a first manifold 236a that connects first branches 212a, 214a, and 216a with a first fill line 234a, which is coupled to first fill hose 230a. The outputs of valves 238b, 240b, and 242b are coupled to a second manifold 236b that connects second branches 212b, 214b, and 216b with a second fill line 234b, which is coupled to second fill hose 230b.

Each of valves 238a, 240a, 242a, 238b, 240b, and 242b are selectively and independently opened and closed under control of a dispenser controller 110 (FIG. 2). In this manner, only one of valves 238a, 240a, and 242a is opened at any one time to supply CNG at selected pressure through first fill hose 230a. Similarly, only one of valves 238a, 240a, and 242a is opened at any one time to supply CNG at a selected pressure through second fill hose 230a.

Valves 238a, 240a, 242a, 238b, 240b, and 242b may be pneumatically-actuated hydraulic valves, which are controlled by controller 110 via respective actuator valves 239a, 241a, 243a, 239b, 241b, and 243b (FIG. 2). These actuator valves 239a, 241a, 243a, 239b, 241b, and 243b may be electrically-actuated pneumatic valves. The use of such a valve system allows the pneumatically-actuated hydraulic valves 238a, 240a, 242a, 238b, 240b, and 242b to be located in the hazardous area of dispenser 205 and the electrically-actuated pneumatic actuator valves 239a, 241a, 243a, 239b, 241b, and 243b to be located in the electrical portion of a cabinet 206 (FIG. 3) of dispenser 205, thus isolating the hazardous area from any electrical lines. Alternatively, fill valves 238a, 240a, 242a, 238b, 240b, and 242b may be electrically-operated explosion proof valves thereby eliminating the need for the electrically-actuated pneumatic actuator valves 239a, 241a, 243a, 239b, 241b, and 243b.

A first meter 244a is provided in fill line 234a for measuring the CNG flowing through it. A second meter 244b is provided in fill line 234b for measuring the CNG flowing through it. As discussed further below, meters 244a and 244b are electrically coupled to dispenser controller 110 (FIG. 2), which reads meter data during various periods of operation.

A first digital pressure sensor 246a is also provided in first fill line 234a proximate first vehicle fill hose 230a for providing pressure readings to controller 110. When filling a vehicle tank using first fill hose 230a, controller 110 may first reads a selected pressure as determined by which grade the user selected by pressing a grade select button 128 (if provided) corresponding to the desired pressure. Controller 110 then opens first low pressure fill valve 238a while keeping closed first medium pressure valve 240a and first high pressure valve 242a such that CNG from the low pressure bank supplied via first supply line 212 is dispensed to the vehicle tank. Controller 110 monitors the pressure readings from first digital pressure sensor 246a, which correspond to the pressure in the vehicle tank when filling the vehicle tank. Thus, controller 110 may monitor the progress of the filling of the vehicle tank and when the pressure reaches a first pressure level corresponding to the low pressure level supplied from first supply line 212 (i.e., 2000 psi), controller 110 may close first low pressure fill valve 238a and open first medium pressure valve 240a while keeping closed first high pressure valve 242a such that CNG from the medium pressure bank supplied via second supply line 214 is dispensed to the vehicle tank. Then, when the pressure reaches a second pressure level corresponding to the medium pressure level supplied from second supply line 214 (i.e., 3000 psi), controller 110 may close first medium pressure fill valve 240a. If the pressure selected by the user is 3000 psi, the sale is completed. On the other hand, if the pressure selected by the user is 3600 psi, controller 110 opens first high pressure valve 242a while keeping closed first low pressure valve 238a and first medium pressure valve 240a such that CNG from the high pressure bank supplied via third supply line 216 is dispensed to the vehicle tank. Once the pressure reaches a third pressure level corresponding to the user-selected pressure, controller 110 closes first high pressure valve 242a and completes the sale.

It will be apparent to those skilled in the art that the second branches with associated fill valves 238b, 240b, and 242b that are used to feed second fill line 234b and fill hose 230b may be operated in the same manner.

A digital temperature sensor 270 (FIG. 2) reads the ambient temperature of the outside air surrounding dispenser 205 and supplies the temperature data to controller 110. Controller 110 may use the ambient temperature reading to adjust the pressure to which the vehicle tank is to be filled. For example, if the proper pressure for a vehicle is 3600 psi at 60° F., controller 110 reduces the pressure at colder temperatures such that the CNG does not over-pressurize as it warms up. Likewise, controller 110 increases the pressure at warmer temperatures. Controller 110 may display the ambient temperature on ambient temperature display 120.

As noted above, the system further includes vent line 252 (FIG. 1), which connects to vent hoses 250a and 250b extending from respective nozzles 232a and 232b via check valves 254a and 254b.

Dispenser 205 further includes a pressure relief valve 256, which is coupled to pressure relief lines 235a and 235b branching off of fill lines 234a and 234b, respectively. Pressure relief valve 256 may open and vent to vent line 252 when the pressure in either of pressure relief lines 235a and 235b exceeds a predetermined pressure of, for example, 4500 psi. Pressure relief lines 235a and 235b may include check valves 258a and 258b, respectively. A manually operated bleed valve 260 may be connected between pressure relief lines 235a and 235b and vent line 252 to bleed off excess pressure in fill lines 234a and 234b to vent line 252.

Dispenser 205 may further include analog pressure gauges 248a and 248b for displaying pressure in fill lines 234a and 234b, respectively. Such gauges 248a, 248b provide a way to confirm the accuracy and calibration of the digital pressure sensors 246a and 246b.

Having generally described the basic structure of the LNG flow control components 210a of dispenser 205, reference is made to FIG. 2, which shows the electronic components 207 of dispenser 205.

As already mentioned, dispenser 205 includes dispenser controller 110; meters 244a and 244b; temperature sensor 270; pressure sensors 246a and 246b; fill valves 238a, 240a, 242a, 238b, 240b, and 242b; and optional actuator valves 239a, 241a, 243a, 239b, 241b, and 243b. Dispenser controller 110 may comprise one or more of: microprocessors or equivalents thereof, programmed logic arrays, digital-to-analog converters, analog-to-digital converters, clocks, memory, buffers, and any other analog or digital circuitry to perform the functions described herein.

Dispenser 205 further includes a communication interface 112 that enables controller 110 to send and receive communications to and from a control console 200 that may control the pressure banks of a natural gas farm. According to one embodiment, the communication interface 112 and control console 200 may be coupled to one another through a network and communicate with one another using a PLC communication protocol. An example of a preferred protocol is disclosed in U.S. Provisional Application No. 61/793,256, entitled “IMPROVED FUEL DISPENSERS” filed on Mar. 15, 2013 by Sarah Ann Lambrix et al., the entire disclosure of which is incorporated herein by reference.

As also shown in FIGS. 3 and 4, dispenser 205 may further include the aforementioned fill hoses 230a and 230b, fill nozzles 232a and 232b, and a user interface section 265 including a user interface keyboard or numeric keypad 114, user interface buttons 116, a dispenser display 118, an ambient temperature display 120, a pressure display 122, a sale/GGE display 124, one or more grade selection displays 126, one or more optional grade selection buttons 128, a receipt printer 130, a card reader 132, and a stop button 134. User interface buttons 116 are preferably capacitive touch switches to reduce the risk of a spark. Buttons 116 and dispenser display 118 are multifunctional. A duplicate user interface section 265 may be provided on the other side of dispenser 205 for use by a user operating fill hose 230b.

Controller 110 may control display 118 to show graphic displays. One such graphic display is a fill indicator bar, which displays the relative levels at which the vehicle tank is filled based upon the sensed pressure relative to the desired pressure. FIG. 5 shows an example of such a graphic fill indicator display 300. The graphic fill indicator display 300 includes a graphic representation of a vehicle CNG tank 302 and may include a textual message 304. When a fill is in progress, the tank graphic 302 is initially all colored white representing an empty tank. The textual message 304 may read “Fill in Progress.” As the vehicle tank fills, the tank graphic 302 shown on display 118 gradually changes in color from white to blue from the bottom of the tank upward to an extent proportional to the amount the vehicle tank is filled. For example, when the vehicle tank is half filled (as determined by the pressure of the tank relative to the selected pressure), tank graphic 302 is colored such that the bottom half is blue. When the vehicle tank is full, the tank graphic 302 turns all green and the textual message 304 reads “Full Fill.”

In addition, display 118 may be used to display graphic training illustrations such as those disclosed in U.S. Provisional Application No. 61/793,256, entitled “IMPROVED FUEL DISPENSERS” filed on Mar. 15, 2013 by Sarah Ann Lambrix et al., the entire disclosure of which is incorporated herein by reference.

Pressure display 122 is provided to display the pressure of the CNG fuel as sensed by a corresponding pressure sensor 246a or 246b.

Sale/GGE display 124 is provided to display the sale cost (in dollars) and the gasoline gallon equivalent (GGE) or mass in pounds or kilograms of the CNG dispensed to the vehicle tank as measured by a corresponding meter 244a or 244b. The GGE information may be displayed on an alternative existing display of dispenser such as displays 118, 120,122, and 126 or on an additional display. Stop button 134 is provided for initiating an emergency stop.

Dispenser 205 may further include an optional gas sensor 138, a boot nozzle sensor 140, and a fresh air purge system 142.

Gas sensor 138 is provided for sensing methane gas in the environment outside the dispenser cabinet. If gas is sensed, controller 110 performs a shutdown procedure at least until such time that gas is no longer sensed. This is an improvement over prior systems where a gas sensor was coupled to a remote controller that would shut down the dispenser in a less than orderly manner.

Boot nozzle sensor 140 senses when the nozzle 232a, 232b is inserted in a nozzle boot 274 and provides this information to controller 110. In essence, boot nozzle sensor 140 serves as an on/off switch. Nozzle boot 274 may also include a locking mechanism for locking nozzle 232a or 232b in nozzle boot 274 when the dispenser is not operational.

Fresh air purge system 142 is provided in the upper chamber of the dispenser cabinet where the electrical components 207 are located to purge the air in this chamber with fresh air. This maintains a positive pressure in the electrical chamber, which keeps any methane gas from reaching the electrical components.

Components 210b of a second embodiment of a CNG dispenser are shown in FIG. 6, which is designed for a one-pressure bank system where a vent line 252 and only a high pressure supply line 216 are provided. In this embodiment, some of the components are eliminated and the remaining components are the same as those mentioned above. In essence, the second embodiment eliminates supply lines 212 and 214, main shut off valves 218 and 220, filters 224 and 226, fill valves 238a, 238b, 240a, and 240b, and manifolds 236a and 236b.

In operation, controller 110 simply fills from a high pressure supply line (i.e., 4000 psi) by opening valve 242a or 242b depending on which fill hose 230a or 230b is being used, and keeping the valve open while monitoring the pressure reading from the corresponding pressure sensor 246a or 246b until the selected pressure is reached at which point controller 110 closes valve 242a or 242b and completes the sale.

Although the second embodiment does not provide the advantage of being capable of being used with a three-bank system, it still provides all of the other novel features and thus benefits from their advantages.

Although both of the above embodiments above show dispensers with two fill hoses, the various aspects of the present invention may be implemented in dispensers having one fill hose or dispensers having more than two fill hoses. Examples of two embodiments having four fill hoses (two per side) are shown in FIGS. 7 and 8 and described further below.

In the embodiment shown in FIG. 7, all of the components are identical to the embodiment shown in FIG. 1 except that the components 210c of the embodiment shown in FIG. 7 include the following additional components: a third fill hose 230c, a third nozzle 232c, a third vent hose 250c, a third check valve 254c, a fourth fill hose 230d, a fourth nozzle 232d, a fourth vent hose 250d, a fourth check valve 254d, first, second, third, and fourth pressure relief valves 256a, 256b, 256c, and 256d, and first, second, third, and fourth hose selection valves 261a, 261b, 261c, and 261d. First and third pressure relief valves 256a and 256c may be configured to vent at about 3750 psi, whereas second and fourth pressure relief valves 256b and 256d may be configured to vent at about 4000 psi.

In the embodiment shown in FIG. 7, the system operates similar to the embodiment of FIG. 1 except that for each side of dispenser, a fill hose is provided for delivering CNG at 3000 psi (first and third fill hoses 230a and 230c) and a fill hose is provided for delivering CNG at 3600 psi (second and fourth fill hoses 230b and 230d). Accordingly, controller 110 controls hose selection valves 261a and 261d to open one of those valves and close the other valve depending upon the pressure selected by the user so that CNG is delivered to the appropriate one of fill hoses 230a and 230d corresponding to the selected pressure. Controller 110 similarly controls hose selection valves 261b and 261c to select to which fill hose 230b or 230c to deliver CNG associated with the user selected pressure. This allows different nozzles to be used for different pressures.

In the embodiment shown in FIG. 8, all of the components are identical to the embodiment shown in FIG. 6 except that the components 210d of the embodiment shown in FIG. 8 includes the following additional components: a third fill hose 230c, a third nozzle 232c, a third vent hose 250c, a third check valve 254c, a fourth fill hose 230d, a fourth nozzle 232d, a fourth vent hose 250d, a fourth check valve 254d, first, second, third, and fourth pressure relief valves 256a, 256b, 256c, and 256d, and first, second, third, and fourth hose selection valves 261a, 261b, 261c, and 261d. First and third pressure relief valves 256a and 256c may be configured to vent at about 3750 psi, whereas second and fourth pressure relief valves 256b and 256d may be configured to vent at about 4000 psi.

In the embodiment shown in FIG. 8, the system operates similar to the embodiment of FIG. 6 except that for each side of dispenser 205, a fill hose is provided for delivering CNG at 3000 psi (first and third fill hoses 230a and 230c) and a fill hose is provided for delivering CNG at 3600 psi (second and fourth fill hoses 230b and 230d). Accordingly, controller 110 controls hose selection valves 261a and 261d to open one of those valves and close the other valve depending upon the pressure selected by the user so that CNG is delivered to the appropriate one of fill hoses 230a and 230d corresponding to the selected pressure. Controller 110 similarly controls hose selection valves 261b and 261c to select to which fill hose 230b or 230c to deliver CNG associated with the user selected pressure. This allows different nozzles to be used for different pressures.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the claims as interpreted according to the principles of patent law, including the doctrine of equivalents.

What is claimed is:

1. A CNG dispenser comprising:
a cabinet;
a fill hose extending from said cabinet;
a pressure sensor disposed to sense a pressure within said fill hose that corresponds to a pressure of a vehicle tank when said fill hose is coupled to the vehicle tank;
a high pressure fill valve disposed between a high pressure CNG supply line and said fill hose;
at least one user-actuatable button disposed on said cabinet for allowing a user to select a pressure to which to fill the vehicle tank with CNG; and
a controller coupled to said at least one user-actuatable button, said pressure sensor, and said high pressure fill valve for opening said high pressure fill valve to dispense high pressure CNG into the vehicle tank while monitoring the pressure of the vehicle tank as sensed by said pressure sensor until the pressure reaches the user-selected pressure.

2. The CNG dispenser of claim 1, and further comprising:
a low pressure fill valve disposed between a lower pressure CNG supply line and said fill hose; and
a medium pressure fill valve disposed between a medium pressure CNG supply line and said fill hose,
wherein said controller initially opens said low pressure fill valve to dispense low pressure CNG into the vehicle tank while monitoring the pressure of the vehicle tank as sensed by said pressure sensor until the pressure reaches a first pressure threshold, once said first threshold is reached, said controller closes said low pressure fill valve and opens said medium pressure fill valve to dispense medium pressure CNG into the vehicle tank while monitoring the pressure of the vehicle tank as sensed by said pressure sensor until the pressure reaches a second pressure threshold, once said second threshold is reached, said controller closes said medium pressure fill valve and opens said high pressure fill valve to dispense the high pressure CNG into the vehicle tank while monitoring the pressure of the vehicle tank as sensed by said pressure sensor until the pressure reaches the user-selected pressure.

3. The CNG dispenser of claim 1, and further comprising a grade selection display for displaying the pressure selected by the user.

4. The CNG dispenser of claim 1, and further comprising a graphic display for displaying a fill indicator bar, which displays relative levels at which the vehicle tank is filled based upon a sensed pressure of the vehicle tank relative to the selected pressure.

5. The CNG dispenser of claim 1, and further comprising an ambient temperature sensor for reading an ambient temperature of the outside air surrounding the dispenser and supplying the temperature data to said controller, wherein said controller adjusts the pressure to which the vehicle tank is to be filled in response to the temperature data.

6. The CNG dispenser of claim 1, and further comprising a gas sensor coupled to said controller for sensing methane gas in proximity to the dispenser, wherein if gas is sensed, said controller performs a shutdown procedure until such time that methane gas is no longer sensed by said gas sensor.

7. The CNG dispenser of claim 1, wherein said fill valve is an electrically-operated explosion proof valve.

8. The CNG dispenser of claim 1, wherein said fill valve is a pneumatically-actuated hydraulic valve, which is controlled by said controller via an electrically-actuated pneumatic valve.

9. A CNG dispenser comprising:
a cabinet;
a fill hose extending from said cabinet;
a pressure sensor disposed to sense a pressure within said fill hose that corresponds to a pressure of a vehicle tank when said fill hose is coupled to the vehicle tank;
a low pressure fill valve having an input configured to be coupled to a lower pressure CNG supply line, and an output coupled to said fill hose;
a medium pressure fill valve having an input configured to be coupled to a medium pressure CNG supply line, and having an output coupled to said fill hose;
a high pressure fill valve having an input configured to be coupled to a high pressure CNG supply line, and having an output coupled to said fill hose; and
a controller coupled to said pressure sensor, and said low, medium, and high pressure fill valves, wherein said controller is operable in a selected one of two modes of operation that may be selected by an operator of a filling station where the CNG dispenser is located, the two modes of operation include a one-pressure bank operation mode in which only the input of said high pressure fill valve is coupled to a CNG supply line, and a three-pressure bank operation mode in which the inputs of each of said fill valves are coupled to respective CNG supply lines.

10. The CNG dispenser of claim 9, wherein, when in a one-pressure bank operation mode, said controller is configured to open said high pressure fill valve to dispense high pressure CNG into a vehicle tank while monitoring the pressure of the vehicle tank as sensed by said pressure sensor until the pressure reaches a threshold pressure.

11. The CNG dispenser of claim 10, wherein, when in a three-pressure bank operation mode, said controller is configured to initially open said low pressure fill valve to dispense low pressure CNG into the vehicle tank while monitoring the pressure of the vehicle tank as sensed by said pressure sensor until the pressure reaches a first pressure threshold, once said first threshold is reached, said controller closes said low pressure fill valve and opens said medium pressure fill valve to dispense medium pressure CNG into the vehicle tank while monitoring the pressure of the vehicle tank as sensed by said pressure sensor until the pressure reaches a second pressure threshold, once said second threshold is reached, said controller closes said medium pressure fill valve and opens said high pressure fill valve to dispense the high pressure CNG into the vehicle tank while monitoring the pressure of the vehicle tank as sensed by said pressure sensor until the pressure reaches a third threshold pressure.

12. The CNG dispenser of claim 9, wherein, when in a three-pressure bank operation mode, said controller is configured to initially open said low pressure fill valve to dispense low pressure CNG into the vehicle tank while monitoring the pressure of the vehicle tank as sensed by said pressure sensor until the pressure reaches a first pressure threshold, once said first threshold is reached, said controller closes said low pressure fill valve and opens said medium pressure fill valve to dispense medium pressure CNG into the vehicle tank while monitoring the pressure of the vehicle tank as sensed by said pressure sensor until the pressure reaches a second pressure threshold, once said second threshold is reached, said controller closes said medium pressure fill valve and opens said high pressure fill valve to dispense the high pressure CNG into the vehicle tank while monitoring the pressure of the vehicle tank as sensed by said pressure sensor until the pressure reaches a third threshold pressure.

13. The CNG dispenser of claim 12 and further comprising:
at least one user-actuatable button disposed on said cabinet for allowing a user to select a pressure to which to fill the vehicle tank with CNG,
wherein said controller is coupled to said at least one user-actuatable button to read the selected pressure, and said controller sets the third threshold pressure to the selected pressure.

14. The CNG dispenser of claim 10 and further comprising:
at least one user-actuatable button disposed on said cabinet for allowing a user to select a pressure to which to fill the vehicle tank with CNG,
wherein said controller is coupled to said at least one user-actuatable button to read the selected pressure, said controller sets the threshold pressure to the selected pressure.

15. The CNG dispenser of claim 14, and further comprising a grade selection display for displaying the pressure selected by the user.

16. The CNG dispenser of claim 9, and further comprising a graphic display for displaying a fill indicator bar, which displays relative levels at which the vehicle tank is filled based upon a sensed pressure of the vehicle tank relative to the selected pressure.

17. The CNG dispenser of claim 9, and further comprising an ambient temperature sensor for reading an ambient temperature of the outside air surrounding the dispenser and supplying the temperature data to said controller, wherein said controller adjusts the pressure to which the vehicle tank is to be filled in response to the temperature data.

18. The CNG dispenser of claim 9, and further comprising a gas sensor coupled to said controller for sensing methane gas in proximity to the dispenser, wherein if gas is sensed, said controller performs a shutdown procedure until such time that methane gas is no longer sensed by said gas sensor.

19. The CNG dispenser of claim 9, wherein said fill valves are electrically-operated explosion proof valves.

20. The CNG dispenser of claim 9, wherein said fill valves are pneumatically-actuated hydraulic valves, which are controlled by said controller via respective electrically-actuated pneumatic valves.
